(19) United States
(12) Patent Application Publication
(10) Pub. No.: US 2013/0182110 A1
(43) Pub. Date: Jul. 18, 2013

(54) METHOD, DEVICE AND INTEGRATED SYSTEM FOR PAYMENT OF PARKING FEES BASED ON CAMERAS AND LICENSE PLATE RECOGNITION TECHNOLOGY

(71) Applicant: PARX LTD., Rosh Pina (IL)

(72) Inventors: Ofer TZIPERMAN, Shimsheet (IL); Arnon Efraty, Tel Aviv (IL)

(73) Assignee: PARX LTD., Rosh Pina (IL)

(21) Appl. No.: 13/743,547

(22) Filed: Jan. 17, 2013

Related U.S. Application Data
(60) Provisional application No. 61/587,168, filed on Jan. 17, 2012.

(51) Int. Cl. H04N 7/18

(52) U.S. Cl. CPC H04N 7/18
USPC 348/148

(57) ABSTRACT

System and method for billing of parking fees, including providing a camera adjacent to a supervised parking spot, the camera is located and aimed so as to have a License Plate Number (LPN) of vehicles driving along a lane adjacent to the supervised parking spot and parking in the supervised parking spot within the field of view (FOV) of the camera at least at some time; taking images, in at least one of which LPNs of the vehicles driving along a lane adjacent to the parking spot and parking in the supervised parking spot is visible and clear enough for later extraction; monitoring vehicles travelling along the road lane adjacent to the supervised parking lane; sensing that a vehicle has parked in the supervised parking spot; extracting the LPN of the parking vehicle from the image; and according the parking vehicle an LPN that has been captured for that vehicle.

### CROSS REFERENCE TO RELATED APPLICATIONS

This Application claims the benefit of U.S. Provisional Application Ser. No. 61/587,168, filed Jan. 17, 2012, and entitled: “A METHOD, DEVICE & INTEGRATED SYSTEM FOR PAYMENT OF PARKING FEES BASED ON OVERHEAD STREET CAMERAS AND LICENSE PLA IE RECOGNITION TECHNOLOGY” which is hereby incorporated by reference in its entirety.

### FIELD OF THE INVENTION

The present invention is in the field of parking management. More particularly, the present invention is in the technical field of collecting parking fees using street cameras and automatic License Plate Number (LPN) recognition technology.

### BACKGROUND OF THE INVENTION

Conventional means of payment of parking fees include various types of parking meters such as single space parking meters, multi space parking meters, also known as “Pay & Display systems”, and the more advanced payment systems recently introduced such as personal parking meters, also referred to as “in car meters”, and mobile telephone and smart phone payment systems.

Conventional means for payment of parking fees may be inconvenient for the driver as well as for enforcement agencies. Each of the parking means mentioned above is not fully automated and requires some manual operations to be performed by the driver. When using single space or multi space parking meters the driver has to leave his car, walk to the meter, pay and get back to his car. Using in car meters, the driver is required to activate the in car meter. Even the most advanced mobile phone and smart phone payment applications require tedious calls to a parking call center for activation and termination of parking. Parking pay by phone payment systems may also require a time consuming and expensive enforcement process.

### SUMMARY OF THE INVENTION

According to embodiments of the present invention, a method for billing of parking fees is provided The method may include: providing at least one camera assembly, each may include a camera adjacent to a supervised parking spot, the camera is located and aimed with respect to the supervised parking spot so as to have a License Plate Number of vehicles driving along a lane adjacent to the supervised parking spot and parking in the supervised parking spot within the field of view of the camera at least at some time; taking images, substantially all of the vehicles in at least one of which License Plate Numbers of the vehicles driving along a lane adjacent to the parking spot and parking in the supervised parking spot is visible and clear enough for later extraction; monitoring vehicles travelling along the road lane adjacent to the supervised parking lane; sensing that a vehicle has parked in the supervised parking spot; extracting the License Plate Number of the parking vehicle from the image in which the License Plate Number is visible and clear enough for extraction; and according the parking vehicle a License Plate Number that has been captured for that vehicle while within the Field of View of the camera.

Furthermore, according to embodiments of the present invention the method may include: recognizing a user associated with the parking vehicle based on the extracted License Plate Number; and billing parking fees from the user.

Furthermore, according to embodiments of the present invention the method may include: recording the time of parking start after sensing the parking vehicle; sensing that the vehicle has left the parking spot; and recording the time of parking end, wherein the parking fees are based on the time the vehicle has parked.

Furthermore, according to embodiments of the present invention the method may include: obtaining location of the parking spot, wherein the parking fees are based on the location of the parking spot

Furthermore, according to embodiments of the present invention the method may include: obtaining the ID of the parking spot, wherein the parking fees are based on the ID of the parking spot

Furthermore, according to embodiments of the present invention the camera assembly may include a processing unit, and wherein the steps of monitoring, sensing, extracting and according are performed by a software application installed on the processing unit.

Furthermore, according to embodiments of the present invention the method may include sending vehicle's License Plate Number to a back end system, wherein the back end system to recognize a user associated with the parking vehicle based on the License Plate Number and bill parking fees from the user.

Furthermore, according to embodiments of the present invention the method may include sending the image of the parking vehicle in which the License Plate Number of the parking vehicle is visible to a back end system.

Furthermore, according to embodiments of the present invention the step of sensing that a vehicle is parking in a supervised parking spot may be performed by an occupancy sensor.

Furthermore, according to embodiments of the present invention the method may include determining if parking rules have been violated by the parking vehicle.

Furthermore, according to embodiments of the present invention the method may include generating and sending a parking ticket to a user associated with the parking vehicle that has violated parking rules.

Furthermore, according to embodiments of the present invention the method may include sending a message to a parking officer if parking rules were violated by the parking vehicle, the message addressing the parking officer to the parking spot

Furthermore, according to embodiments of the present invention the method may include sending a message to a user associated with the parking vehicle if parking rules were violated by the parking vehicle.

According to embodiments of the present invention, there is provided a system for billing of parking fees, the system may include: at least one camera assembly located adjacent to a supervised parking spot, each of the at least one camera assembly may include: a camera, located and aimed with respect to the supervised parking spot so as to have a License Plate Number of a vehicles driving along a lane adjacent to the supervised parking spot and parking in the supervised parking spot within the field of view of the camera at least at some time, the camera may take images, in at least one of which License Plate Numbers of the vehicles driving along a lane adjacent to the parking spot and parking in the supervised parking spot is visible and clear enough for later extraction; a first processor may: use image processing tools to analyze the images captured by the camera; monitor vehicles travelling along the road lane adjacent to the supervised parking lane; sense that a vehicle is parking in the supervised parking spot; extract the vehicle's License Plate Number of the parking vehicle from an image in which the License Plate Number of the parking vehicle is visible and clear enough for extraction; accord the parking vehicle a License Plate Number that has been captured for that vehicle while within the Field of View of the camera; and send the vehicle's License Plate Number of the parking vehicle and parking spot identification to a back end system.

Furthermore, according to embodiments of the present invention the system may include: the back end system, wherein the back end system may include a second processor, the second processor may: receive the vehicle's License Plate Number of the parking vehicle and parking spot identification from the at least one camera assembly; recognize a user associated with the parking vehicle based on the License Plate Number; and bill parking fees from the user.

Furthermore, according to embodiments of the present invention the first processor may: record the time of parking start after sensing the parking vehicle; sense that the vehicle has left the parking spot; record the time of parking end; and send the time of parking start and the time of parking end to the back end system, wherein the second processor may calculate parking fees based on the time the vehicle has parked.

Furthermore, according to embodiments of the present invention the first processor may: send location of the parking spot to the back end system, and wherein the second processor may calculate parking fees based on the location of the parking spot.

Furthermore, according to embodiments of the present invention the second processor may determine if parking rules have been violated by the parking vehicle.

Furthermore, according to embodiments of the present invention the second processor may generate and send a parking ticket to a user associated with the parking vehicle that has violated parking rules.

Furthermore, according to embodiments of the present invention the second processor may send a message to a parking officer if parking rules were violated by the parking vehicle, the message addressing the parking officer to the parking vehicle.

Furthermore, according to embodiments of the present invention the second processor may send a message to a user associated with the parking vehicle if parking rules were violated by the parking vehicle.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high-level diagram of an automated system for payment of parking fees using street cameras according to embodiments of the present invention;

FIG. 2 is a flowchart illustration of a method for automated payment of parking fees using street cameras according to embodiments of the present invention.; and

FIG. 3 is a schematic flowchart of a method for acquiring and tracking a travelling vehicle, according a LPN to it and identifying if it parked, according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the present invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

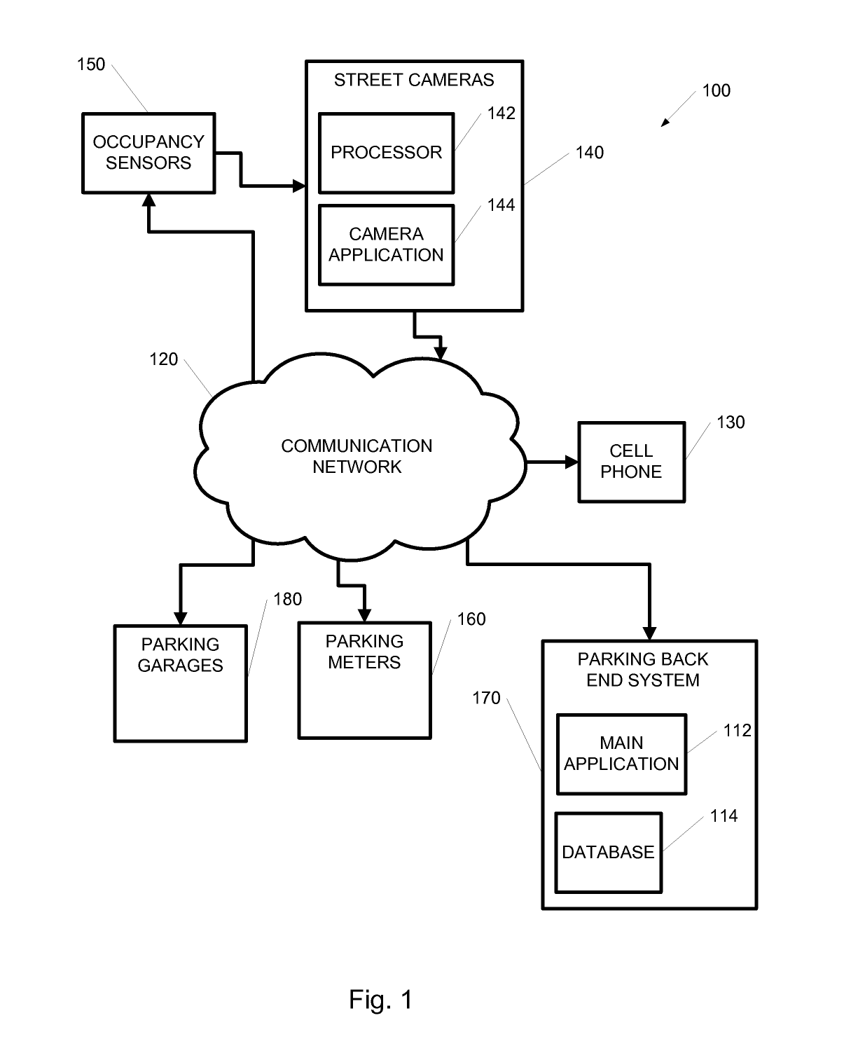

Reference is made to FIG. 1 which is a high-level diagram of an automated system 100 for payment of parking fees using cameras assembly 140. Each camera assembly 140 may include a camera 146, a processing unit 142 and a communication module 148. Camera assembly 140 may also comprise a power supply module 145. Power supply module 145 may include solar panels and/or any other suitable power supply source. For example, power supply module 145 may be connected to the mains. In yet another embodiment camera assembly 140 may be packaged together with a street lamp into a lamp socket of a street light and may be powered from the power source of the light on the street light.

According to embodiments of the present invention, system 100 may include a plurality of camera assemblies 140. Camera assemblies 140 may be installed such that at least some of cameras 146 has in their FOV at least two road lanes, the one that may be used for parking (typically the one that may id adjacent to a pavement) and the one adjacent to it. The road lanes that include parking spots that are within the field of view of cameras 146 are referred to hereinafter as supervised parking lanes. Camera 146 may capture images of parked vehicles, including the license plate number (LPN) of the parked vehicles, in quality sufficient for automatic extraction of the LPN. Camera assembly 140 may be located and aimed with respect to the supervised parking lanes so as to have a License Plate Number of a vehicle driving along and/or parking in the supervised parking lanes within the field of view of camera 146, at least at some time (e.g., just before, during or after parking).

According to some embodiments of the present invention, camera 146 may supervise at least one parking spot. For example, in a typical embodiment four or more parking spots may be supervised by camera 146. Camera 146 may capture images continuously or periodically during predefined time periods, for example, during paid parking hours, or at all times, as may be needed. According to some embodiments camera 146 may capture images in response to a triggering signal, for example that indicates a vehicle occupying a parking spot. For example, an occupancy sensor 150 may detect that a vehicle has started parking and may send a triggering signal to camera assembly 140 that may capture an image of the parked vehicle. Occupancy sensors 150 may communicate with cameras assembly 140 via communication module 148, over communication network 120 or directly using any suitable communication interface and protocol. An exemplary occupancy sensor 150 is described in U.S. patent application Ser. No. 13/386,824 filed on Jan. 24, 2012 to the applicant of the present application, and entitled “FULLY AUTOMATED PARKING SYSTEM”, which is incorporated in its entirety herein by reference.

According to some embodiments of the present invention, camera assembly 140 may include a processing unit 142 for performing image processing and other tasks locally. For example, camera application 144 executable by processing unit 142 may include image processing modules that may analyze images taken by camera 146. According to some embodiments, camera 146 may capture images of the supervised parking lane and the road lane adjacent to it. Camera application 144 may use tracking algorithms for monitoring the vehicles travelling along the road lane adjacent to the supervised parking lane, take images in at least one of which the LPN is visible and clear enough for later extraction and may be capable of determining, for a tracked vehicle that has parked, when the vehicle has parked, in which one of the parking spots of the supervised parking lane it has parked. Application 144 may be able to accord the vehicle that has parked an LPN that has been captured for that vehicle while within the Field Of View (FOV) of cameras 146 either prior to, during or after the parking time. Camera application 144 may detect the incoming vehicle, record the time the vehicle has started parking, extract the LPN of the parked vehicle, detect that the vehicle has left the parking spot, and record the end of parking time. In case camera assembly 140 is notified of parking initiation and termination by other means such as occupancy sensors 150, detection of the incoming and the leaving of vehicle by camera 146 and/or camera application 144 may not be required. In this case, camera 146 may receive a signal from occupancy sensor 150 indicating that a vehicle has started parking, capture an image of the parking vehicle and extract the LPN. Camera application 144 may send analyzed data of a parking session to parking back end system (BES) 170 via communication module 148 over communication network 120. The analyzed data of a parking session may include LPN of the parking vehicle, the time of parking session start and end together with auxiliary data. The auxiliary data may include camera identification number (camera ID), camera location, parking spot identification, (parking spot ID), and other details as may be necessary. The analyzed data may include at least one time stamped image of the parked vehicle, in which the LPN is visible and a record of the time and date in which the image was taken is available, for record keeping and future use. The analyzed data may include a subset of the above, as may be needed by system 100. For example, a reduced analyzed data set may include just the LPN or the LPN and the parking spot ID. Such a reduced analyzed data set may fit a situation in which parking fees are not dependent on parking location or duration.

BES 170 may reside on a single (e.g. main) server or on a plurality of servers. Main application 112 may be installed on BES 170 and may be configured to perform the following functions:

Registration to the service and user management: a vehicle user may register to system 100 by performing registration process which records the user details in a user's registry in back end system 170. For example, the user may register to system 100 as associated with a specific one or more vehicle's LPNs. Registration data may also include data required for collection of parking fees, such as selected means of payment associated with the user, such as credit cards or interbank payment and indication whether parking fees are pre-paid or post paid. Registration data may also include other items such as the user personal identification number, address, phone number, etc. as may be required. Registration data may be stored in a user's database 114 on back end system 170.

Billing—BES 170 may handle the billing of the user for parking sessions made. Billing may be made every agreed period of time (every month, quarter etc.).

Enforcement—BES 170 may be interrogated by a parking officer using communication means such as cellular phones, dedicated devices, WiFi channel, etc., on whether a particular user has paid his parking fees or is registered to the service and as so will be billed according to the system's rules. Embodiments of the present invention may enable partially or fully automated enforcement of parking rules. For example, a parking ticket may be generated and sent to a user that has violated parking rules, e.g., did not set means of payment, exceeded maximum parking time limits, parked at parking spaces assigned for the disabled or for local residents, etc. According to some embodiments, instead of the common practice of inspecting every parking vehicle to find if the user violated parking rules, only vehicles that were recognized by system 100 as violating parking rules may be inspected. For example, once the LPN of a parking vehicle is extracted, system 100, for example, BES 170, may determine if parking fees are duly paid and if no other parking rules are violated. In case a parking rule is violated, a message addressing a parking officer to the parking location, where the specific vehicle that has violated parking rules parks, may be sent by system 100 to a parking officer. The message may include all details necessary for addressing the officer to the violating vehicle, such as the LPN of the vehicle, the location, of the parking space ID, the type of violation, user details etc. The same methodology may be applied in case of parking rules violation such as exceeding max parking time limits, parking at parking spaces assigned for the disabled or for local residents, etc. A similar message may be sent to the user, to inform him of the violation and give the user a chance to correct the violation, for example, by moving his vehicle or payment of due parking fees using a cellular phone

In operation, main application 114 may receive parking data from a plurality of camera assemblies 140. The parking data may include information regarding parking sessions that occur in the parking spots supervised by system 100. According to some embodiments parking data may include images captured by cameras 146, a time stamp for each image indicating the time and date in which the image was taken and auxiliary data as listed hereinabove (e. g., camera ID, camera location, parking spot ID, etc.). Main application 114 may include image processing modules that may analyze the received images and detect an incoming vehicle, record the time the vehicle has started parking based on the time stamp of the images, extract the LPN of the parked vehicle from the image, detect that the vehicle has left the parking spot and record the end of parking time. In some embodiments, image processing tasks may be performed locally by camera application 144 of camera assembly 140, and thus BES 170 may receive analyzed data as described hereinabove. In some embodiments indication of beginning and termination of a parking session may be received from occupancy sensors 150. Main application 114 may receive at least one time stamped image of the parked vehicle for each parking session, in which the LPN is visible, for record keeping and future use.

Main application 114 may store analyzed parking data in user's database 114. For example, for each registered user, main application 114 may store information regarding parking sessions performed by vehicles having an LPN that is associated with that user. The information may include time of beginning and end of the parking session, location of the parking session (e.g., parking space ID), camera ID, image of the vehicle taken during the parking session in which the LPN of the vehicle is visible, relevant parking tariff for the parking spot and specific parking time, etc. Main application 114 may handle the billing of the user using data stored in user's database 114 combined with parking fees data that may be stored at back end system 170.

Once the payment due is determined, payment may be performed in any applicable method. For example, the parking fees may be deducted from a prepaid account associated with the specific user, or may be debited from an account of a credit card number that was related to the user. Alternatively, a bill may be sent to the user.

Back end system 170 may also receive information from other parking management units such as single space and multi space parking meters 1.60, parking occupancy sensors 150 and parking lot gates and automatic payment machines of parking garages 180, in car devices 122, cell phones 130, etc. Thus system 100 and back end system 170 may provide a unified parking management solution.

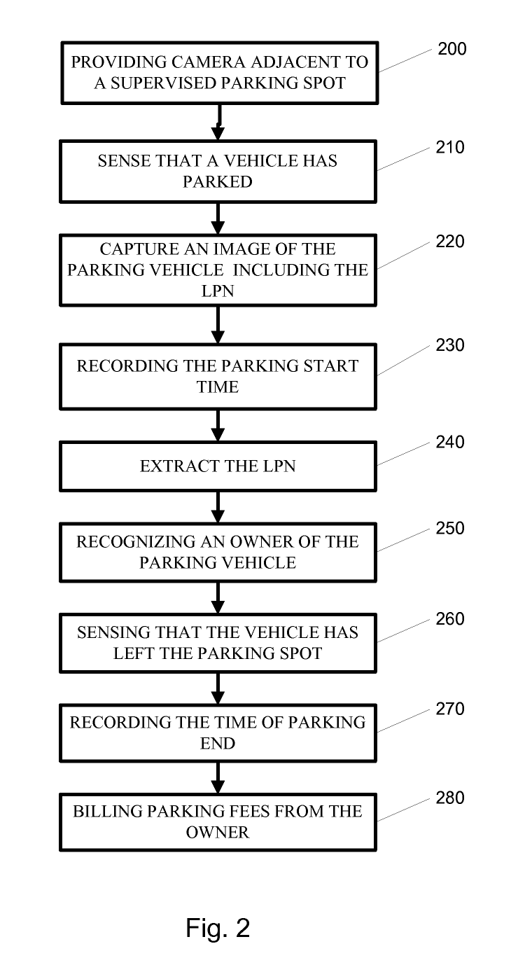

Reference is now made to FIG. 2 which is a flowchart illustration of a method for payment of parking fees using cameras according to embodiments of the present invention. According to embodiments of the present invention, the method for payment of parking fees using cameras may be performed by a system for payment of parking fees using cameras such as, for example, system 100 depicted in FIG. 1.

According to embodiments of the present invention camera assemblies 140 including cameras 146 are provided adjacent to supervised parking spots, as indicated in block 200. In block 210 the supervised parking spots may be scanned and the presence of a parking vehicle in a supervised parking spot may be sensed by using image processing tools to analyze images captured by cameras 146. For example, images of the supervised parking lanes and the road lane adjacent to the supervised parking lanes may be captured. Tracking algorithms may be used for monitoring the vehicles travelling the road lanes adjacent to the supervised parking lanes, for capturing at least one image of the tracked vehicle in which the LPN is visible, clear and extractable and for determining when a vehicle has parked in one of the parking spots of the supervised parking lanes. Images of the supervised parking lanes and the road lanes adjacent to them may be captured continuously or periodically and parking vehicles may be detected using image processing tools running and executed, for example, processing unit 142 or on back end system 170. Alternatively, the parked vehicle may be sensed or detected by other means such as occupancy sensors 150. Once a parked vehicle has been sensed, camera 146 may capture an image of the parking vehicle, the image including the LPN of the parked vehicle, as indicated in block 220. According to some embodiments an image of the vehicle in which the LPN of the parked vehicle is visible and clear enough for later extraction may be captured while the vehicle is travelling along the road lane adjacent to the supervised parking lane, before or after parking. Vehicles travelling along the road lane adjacent to the supervised parking lane may be monitored and tracked so that LPN that has been captured for a parking vehicle while that vehicle has been travelling along the road lane adjacent to the supervised parking lane may be accorded to that vehicle. Thus, the image of the parking vehicle in which LPN of the parked vehicle is visible and clear enough for later extraction may be captured before, during or after the parking time. Additionally, the time of parking start may be recorded, as indicated in block 230. In block 240 the LPN of the parked vehicle is extracted from the captured image using image processing tools. The user of the vehicle may be recognized from the LPN and/or from data associating one or more users with the LPN, as indicated in block 250. A database relating LPNs to users may be stored and used for relating LPNs to users. In block 260 it may be sensed that the parked vehicle has left the parking spot. Sensing of end of parking session may be done by continuously or periodically capturing images of the parking spot and using image analysis tools to detect that the vehicle related to the relevant parking session has left the parking spot. Alternatively, other means, such as occupancy sensors 150, may be used to sense that a vehicle has left the parking spot. In block 270, the time of the end of parking may be recorded. In block 280 parking fees may be calculated based on, for example, the duration and location of parking and the user may be billed with the parking fees.

When multiple street cameras 140 are installed along a road or a street so that their respective FOVs are either overlapping each its neighbors FOV, or tangential to its neighbor's or having relatively small gaps between them, data acquired and extracted based on images captured in one FOV may be used for supporting the operation of the system of the current invention by completing information related to images captured in other FOVs. Thee FOV of the multiple street cameras 140 will be denoted herein after the numerator n, where n will have the value of 1 for the first street camera in a line of street cameras and the value of n will be increased, for example by one, for each consequent street camera 140. It will be apparent that a images of a vehicle travelling along an, or parking in an area having one lane in which at least some parking spaces are defined and another lane adjacent to it may be captured by one or more of the street cameras 140. Further, the LPN of the vehicle may be undisclosed to the camera in its FOV is it currently situated, at least for some time and at least when located at certain locations in the FOV and situated in certain positions with respect to street camera 140. It is assumed that at least some of the parking spaces in an area covered by a certain street camera 140 are visible to that camera. The multiple street cameras 140 may be aimed, when in the stage of initial installation or at anytime later, to cover a desired FOV. The street cameras 140 may be aimed to form a substantially continuous or almost coverage by a mosaic of the separate FOVs. At any time after the installation of the series of street cameras 140 the FOV of the cameras, or at least of some of them, may be mapped to locations in the FOV. For example, a parking space viewed in a FOV of street camera n may be mapped onto the frame of the camera so that the portion of the frame occupied by it may be recorded as representing and reflecting that parking space. Accordingly, for parking spaces having denomination system, the ID of a certain parking space may be associated with its respective portion of camera frame. In other instances a parking space may be marked so that its marking is visible in the FOV of the street camera in the FOV of which it is included. In such cases the marking of the parking space may be extracted, e.g. if it is in the form of a bar-code or a QR code, and thus its ID may be identified via the captured image of the FOV. Further, a vehicle viewed in a frame of a certain FOV may be considered as ‘parking’ if its location in the frame is static for at least pre-defined period of time, e.g. 5 minutes. The visibility of a LPN of a vehicle located and/or travelling through the area covered by the series of street cameras 140 may be interrupted by one or more of another vehicle travelling nearby, an interruption in the FOV (such as a branch of a tree) or due to the fact that the LPN is facing away from the camera. Accordingly, it is possible that the LPN of a vehicle travelling along and eventually parking in a parking place will not be disclosed, in a sufficient exposure, to the camera in the FOV of which the vehicle has parked.

As indicated above a vehicle travelling along may, in any of the FOVs of the series of street cameras 140, park or not park, have its LPN exposed clear and long enough to the street camera covering the respective area to enable extraction of the LPN number, or not. According to embodiments of the present invention if the LPN of a vehicle of interest may be extracted based on frame or frames taken in one FOV while the same vehicle parks, or will park in a parking space covered by another camera, the LPN extracted from FOV and frames prior to the parking or after the parking can be accorded to its vehicle.

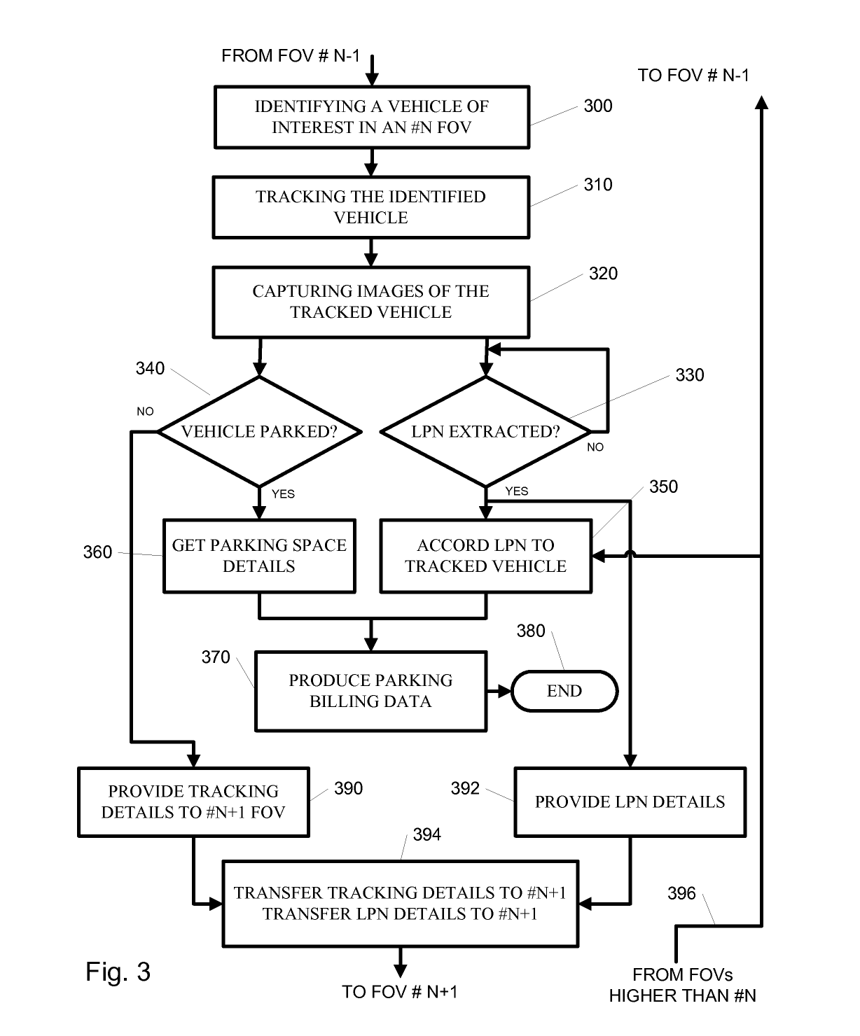

Reference is made now to FIG. 3, which is a schematic flowchart of a method for acquiring and tracking a travelling vehicle, according a LPN to it and identifying if it parked, according to embodiments of the present invention. FIG. 3 presents a method performed for vehicles captured in the FOV of street camera 140 number n. the method described herein below allows tracking information to be used when processing tracked vehicle information captured by other street cameras located after the current camera with respect to the direction of progress of a tracked vehicle and allows LPN extracted data be used when processing information of a LPN of a tracked vehicle captured in the FOV of street cameras located before or after the current camera, with respect to the direction of progress of the tracked vehicle. Data characterizing a travelling vehicle that is about to travel from an area covered by and associated with a certain street camera with FOV numbered n-l to the area associated with the FOV numbered n may include shape, size, irregular contour characteristics, etc.—such features that may assist in keeping continuous track of a certain vehicle when it is crossing from the area covered by one camera (i.e. one FOV) to that of its successive camera (i.e. successive FOV). A tracked vehicle may be associated a temporary vehicle ID (herein after TVID). When a vehicle ids tracked by the system according to embodiments of the present invention its TVID may be used to associate, for example, a LPN to that vehicle. The TVID of a certain vehicle may be deleted once that vehicle has left the area supervised and covered by the series of street cameras.

A vehicle entering a FOV number n may be accompanied with characterizing information acquired and/or extracted when that vehicle was travelling across areas covered by FOV with numbers preceding n. That vehicle may be identified, optionally relying (also) on characterizing information received from previously processed data (block 300. a tracking program may start, or continue tracking that vehicle (block 310) and may capture frames of that vehicle (block 320). As the case may be, and in unrelated manner, the LPN of the vehicle may, or may not be disclosed, captured and extracted (decision point block 330) and the tracked vehicle may, or may not, park in parking space located within the n-th FOV. In case the tracked vehicle has parked and its LPN was extracted, either during its travel across the n-th FOV or previously or, in later processing, during its travel across FOV with higher values of n. When both, the vehicle has parked and the parking space data is fetched (block 360) and the LPN is known, the LPN is associated with data characterizing the parking space (block 350) and this information may be provided to BES 170 (block 370) for further handling. If during the travel of the vehicle across the n-th FOV it did not park, tracking information (such as the tracking characterizing data) may be made available for use when tracking continuous in the n+1-th FOV or later on (block 390). If the LPN of the vehicle travelling across the area covered by the n-th FOV was extracted, either previously or during this travel, but the vehicle ahs not parked in any of the parking spaces included in the area of the n-th FOV the LPN information may be provided for later calculation (block 392). The composition of data acquired and/or received when the vehicle travelled across the area covered by the n-th FOV may be provided for later use (block 394).

In case the tracked vehicle parked in FOV with certain n number but its LPN was extracted only based on images/frames captured in FOV having higher n number, that data may be used for late processing and association of the LPN extracted late, with a vehicle that parked earlier, as indicated by arrow numbered 396.

Some embodiments of the present invention may be implemented in software for execution by a processor-based system, for example, camera application 144 and main application 112. For example, embodiments of the present invention may be implemented in code or software and may be stored on a non-transitory storage medium having stored thereon instructions which, when executed by a processor, cause the processor to perform methods as discussed herein, and can be used to program a system to perform the instructions. The non-transitory storage medium may be, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the present invention may comprise dedicated, custom, custom made or off the shelf hardware, firmware or a combination thereof.

Embodiments of the present invention may be realized by a system that may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for billing of parking fees, the method comprising:
providing at least one camera assembly, each comprising a camera adjacent to a supervised parking spot, the camera is located and aimed with respect to the supervised parking spot so as to have a License Plate Number of vehicles driving along a lane adjacent to the supervised parking spot and parking in the supervised parking spot within the field of view of the camera at least at some time;
taking images, in at least one of which License Plate Numbers of the vehicles driving along a lane adjacent to the parking spot and parking in the supervised parking spot is visible and clear enough for later extraction;
monitoring vehicles travelling along the road lane adjacent to the supervised parking lane;
sensing that a vehicle has parked in the supervised parking spot;
extracting the License Plate Number of the parking vehicle from the image in which the License Plate Number is visible and clear enough for extraction; and
according the parking vehicle a License Plate Number that has been captured for that vehicle while within the Field of View of the camera.

2. The method of claim 1, comprising:
recognizing a user associated with the parking vehicle based on the extracted License Plate Number; and
billing parking fees from the user.

3. The method of claim 2, comprising:
recording the time of parking start after sensing the perking vehicle;
sensing that the vehicle has left the parking spot; and
recording the time of parking end,
wherein the parking fees are based on the time the vehicle has parked.

4. The method of claim 2, comprising:
obtaining location of the parking spot,
wherein the parking fees are based on the location of the parking spot.

5. The method of claim 1, wherein the camera assembly comprises a processing unit, and wherein the steps of monitoring, sensing, extracting and according are performed by a software application installed on the processing unit.

6. The method of claim 5, comprising sending vehicle's License Plate Number to a back end system, wherein the back end system to recognize a user associated with the parking vehicle based on the License Plate Number and bill parking fees from the user.

7. The method of claim 6, comprising sending the image of the parking vehicle in which the License Plate Number of the parking vehicle is visible to a back end system.

8. The method of claim 1, wherein the step of sensing that a vehicle is parking in a supervised parking spot is performed by an occupancy sensor.

9. The method of claim 1, comprising determining if parking rules have been violated by the parking vehicle.

10. The method of claim 9, comprising generating and sending a parking ticket to a user associated with the parking vehicle that has violated parking rules.

11. The method of claim 9, comprising sending a message to a parking officer if parking rules were violated by the parking vehicle, the message addressing the parking officer to the parking vehicle.

12. The method of claim 9, comprising sending a message to a user associated with the parking vehicle if parking rules were violated by the parking vehicle.

13. A system for billing of parking fees, the system comprising:
at least one camera assembly located adjacent to a supervised parking spot, each of the at least one camera assembly comprising:
a camera, located and aimed with respect to the supervised parking spot so as to have a License Plate Number of a vehicles driving along a lane adjacent to the supervised parking spot and parking in the supervised parking spot within the field of view of the camera at least at some time, the camera to take images, in at least one of which License Plate Numbers of the vehicles driving along a lane adjacent to the parking spot and parking in the supervised parking spot is visible and clear enough for later extraction;
a first processor to:
use image processing tools to analyze the images captured by the camera;
monitor vehicles travelling along the road lane adjacent to the supervised parking lane;
sense that a vehicle is parking in the supervised parking spot;
extract the vehicle's License Plate Number of the parking vehicle from an image in which the License Plate Number of the parking vehicle is visible and clear enough for extraction;
accord the parking vehicle a License Plate Number that has been captured for that vehicle while within the Field of View of the camera; and
send the vehicle's License Plate Number of the parking vehicle and parking spot identification to a back end system.

14. The system of claim 13, further comprising:
the back end system, wherein the back end system comprising a second processor, the second processor to:
receive the vehicle's License Plate Number of the parking vehicle and parking spot identification from the at least one camera assembly;
recognize a user associated with the parking vehicle based on the License Plate Number; and
bill parking fees from the user.

15. The system of claim 14, wherein the first processor is further to:
record the time of parking start after sensing the perking vehicle;
sense that the vehicle has left the parking spot;
record the time of parking end; and
send the time of parking start and the time of parking end to the back end system,
wherein the second processor to calculate parking fees based on the time the vehicle has parked.

16. The system of claim 14, wherein the first processor is further to:
send location of the parking spot to the back end system, and wherein the second processor to calculate parking fees based on the location of the parking spot.

17. The system of claim 14, wherein the second processor is further to determine if parking rules have been violated by the parking vehicle.

18. The system of claim 17, wherein the second processor is further to generate and send a parking ticket to a user associated with the parking vehicle that has violated parking rules.

19. The system of claim 17, wherein the second processor is further to send a message to a parking officer if parking rules were violated by the parking vehicle, the message addressing the parking officer to the parking vehicle.

20. The system of claim 17, wherein the second processor is further to send a message to a user associated with the parking vehicle if parking rules were violated by the parking vehicle.
